(19) United States
(12) Patent Application Publication
(10) Pub. No.: US 2026/0135402 A1
(43) Pub. Date: May 14, 2026

(54) SYSTEMS, METHODS, AND VEHICLES FOR PROVIDNG SECURE CHARGING PORT AT AN EXTERIOR OF VEHICLE

(71) Applicant: Rivian IP Holdings, LLC, Irvine, CA (US)

(72) Inventors: Yeana Annie Cho, Boise, ID (US); David George Butler, San Jose, CA (US); Chelsey Colbert, San Francisco, CA (US); Arjuna Sivasithambaresan, San Francisco, CA (US)

(21) Appl. No.: 19/364,109

(22) Filed: Oct. 21, 2025

Related U.S. Application Data
(60) Provisional application No. 63/719,065, filed on Nov. 11, 2024.

(51) Int. Cl. H02J 7/00; B60L 1/00; B60R 16/033

(52) U.S. Cl. CPC H02J 7/855; B60R 16/033; H02J 7/933; B60L 1/006

(57) ABSTRACT

Systems, methods, and vehicles are disclosed herein. For example, this disclosure securely provides users with a charging port at an exterior of a vehicle. The port may be a wireless charging pad, enabling a user to receive electric power without the need to carry a portable charger and a cable. The port may not be easily visible to those in an environment of the vehicle. The present disclosure provides for supporting the community, e.g., providing a charging mechanism in a natural disaster via the port of the vehicle. The present disclosure provides for protecting the vehicle battery and deterring abuse by utilizing a limited duration for charging (e.g., 1-10 minutes, enough to unlock the vehicle), and/or by not allowing a subsequent charging session unless the vehicle is unlocked.

### CROSS-REFERENCE TO RELATED APPLICATIONS

This application claims the benefit of U.S. Provisional Application No. 63/719,065, filed Nov. 11, 2024, the disclosure of which is hereby incorporated by reference herein in its entirety.

### INTRODUCTION

Smartphones can be used as a key to access a vehicle. However, if a smartphone battery runs out (or smartphone is lost) while a user is away from home at a location, users may end up being locked out of cars, and potentially stranded at the location.

### SUMMARY

As disclosed herein, the present disclosure provides for vehicles, systems, methods, non-transitory computer readable mediums, and apparatuses in which users may securely be provided with a charging port at an exterior of a vehicle. In some embodiments, the port may be a wireless charging pad, enabling a user to receive electric power without the need to carry a portable charger and a cable. In some embodiments, the port may not be easily visible to those in an environment of the vehicle, e.g., “in the know to know.” In some embodiments, the present disclosure provides for supporting the community, e.g., providing a charging mechanism in a natural disaster via the port of the vehicle. In some embodiments, the present disclosure provides for protecting the vehicle battery and deterring abuse by utilizing a limited duration for charging (e.g., 1-10 minutes, enough to unlock the vehicle), and/or by not allowing a subsequent charging session unless the vehicle is unlocked (e.g., based on electrical power received during an initial session at the port), and/or the port may be configured to only provide electrical power to certain devices (e.g., configurable, such as a friend's smartphone, if the owner's smartphone is lost). In some embodiments, a user device may be authenticated, e.g., based on data received via Bluetooth signals or via any other suitable mechanism.

As disclosed herein, the present disclosure provides for vehicles, systems, methods, non-transitory computer readable mediums, and apparatuses in which a port is located at an exterior portion of the vehicle, and processing circuitry configured to detect a signal indicating a user device is coupled to the port, and determine whether to provide, via the port, electrical power to the user device at a first rate or at a second rate, based on whether one or more criteria is met, wherein the second rate is slower than the first rate.

In some embodiments, the one or more criteria comprises whether a state of emergency is associated with a location of the vehicle, and wherein the processing circuitry is further configured to determine that the state of emergency is associated with the location of the vehicle, and, based on determining that the state of emergency is associated with the location of the vehicle, provide, via the port, electrical power to the user device at the first rate.

In some embodiments, the one or more criteria comprises whether the user device is associated with an authenticated user of the vehicle, and the processing circuitry is further configured to determine that the user device is associated with an authenticated user of the vehicle, and, based on determining that the user device is associated with an authenticated user of the vehicle, provide, via the port, electrical power to the user device at the first rate.

In some embodiments, the processing circuitry is further configured to, prior to determining that the user device is associated with the authenticated user of the vehicle, provide, via the port, electrical power to the user device at the second rate.

In some embodiments, the one or more criteria comprises whether the user device is associated with an authenticated user of the vehicle, and the processing circuitry is further configured to determine that the user device is not associated with an authenticated user of the vehicle, and, based on determining that the user device is not associated with an authenticated user of the vehicle, provide, via the port, electrical power to the user device at the second rate for a period of time, and, upon determining that the period of time has elapsed, stop providing the electrical power to the user device via the port.

In some embodiments, the one or more criteria comprises whether the user device is associated with an authenticated user of the vehicle, and the processing circuitry is further configured to determine that the user device is not associated with an authenticated user of the vehicle; based on determining that the user device is not associated with an authenticated user of the vehicle, provide a notification to a user device of an authorized user of the vehicle indicating that an unauthenticated user is attempting to use the port to receive electrical power for their user device; and based on receiving approval from the user device of the authenticated user of the vehicle, provide, via the port, electrical power to the user device at the first rate or the second rate. In some embodiments, the notification further comprises a video of the unauthenticated user in a vicinity of the vehicle.

In some embodiments, the one or more criteria comprises whether the user device is associated with an authenticated user of the vehicle, and the processing circuitry is further configured to determine that the user device is not associated with an authenticated user of the vehicle; based on determining that the user device is not associated with an authenticated user of the vehicle, provide a notification to a user device of an authorized user of the vehicle indicating that an unauthenticated user is attempting to use the port to receive electrical power for their user device; and based on receiving no response to the notification from the user device of the authorized user of the vehicle, or based on receiving selection of a negative option, determine to withhold the electrical power from the user device.

In some embodiments, the one or more criteria comprises whether a state of charge of a battery of the vehicle is below a threshold, and wherein the processing circuitry is further configured to: determine that the state of charge of the battery of the vehicle is below the threshold; and based on determining that the state of charge of the battery of the vehicle is below the threshold, provide, via the port, electrical power to the user device at the first rate or the second rate for a period of time, and, upon determining that the period of time has elapsed, stop providing the electrical power to the user device via the port.

In some embodiments, the one or more criteria comprises whether the user device is associated with an authenticated user of the vehicle and whether a state of charge of a battery of the vehicle is below a threshold, and wherein the processing circuitry is further configured to determine that the user device is not associated with an authenticated user of the vehicle; determine that the state of charge of the battery of the vehicle is below the threshold; and, based on determining that the user device is not associated with an authenticated user of the vehicle and that the state of charge of the battery of the vehicle is below the threshold, determine to withhold the electrical power from the user device.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 shows a block diagram of components of a system for securely providing electrical power to a user device, in accordance with some embodiments of the present disclosure;

FIG. 2 shows a block diagram of components of a system for securely providing electrical power to a user device, in accordance with some embodiments of the present disclosure;

FIGS. 3A-3B show illustrative ports at an exterior portion of a vehicle, in accordance with some embodiments of the present disclosure;

FIG. 4 shows a flowchart of an illustrative process for providing electrical power to an accessory via a port located at an exterior portion of a vehicle, in accordance with some embodiments of this disclosure.

FIG. 5 shows a flowchart of an illustrative process for providing electrical power to an accessory via a port located at an exterior portion of a vehicle, in accordance with some embodiments of this disclosure.

### DETAILED DESCRIPTION

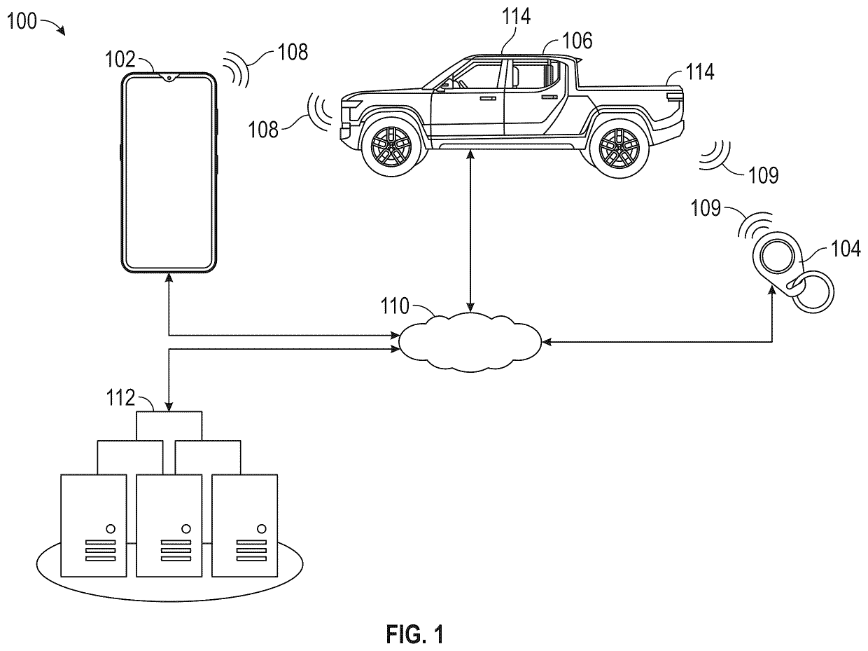

FIG. 1 shows a block diagram of components of a system for securely providing electrical power to a user device, in accordance with some embodiments of the present disclosure. System 100 may comprise vehicle 106, one or more of user device 102 (e.g., a mobile device, such as, for example, a smartphone or a tablet or any other suitable user device or any combination thereof) and user device 104 (e.g., a key fob), and/or cloud computing resources 112 (e.g., one or more servers, which may include or be in communication with one or more databases). Such elements of system 100 may be configured to communicate over a first communication path and/or a second communication path. The first communication path may be associated with, e.g., a short-range radio communication technique, such as, for example, Bluetooth low energy (BLE) 108 or near-field communication (NFC) 109. The second communication path may be associated with network 110, e.g., the Internet, a local area network (LAN), a wide area network (WAN), a cellular network, a satellite network and/or any other suitable network. User device 102 and/or 104 may be operable by a user to perform, or instruct performance of, various functions in connection with vehicle 106 (e.g., unlocking and locking doors or hatches, pairing to a media system of vehicle 106, starting or turning off vehicle 106, signaling a panic condition, and/or any other suitable functions) over the first communication path. In some embodiments, user device 102 may be configured to implement a phone-as-key (PAK) feature by communicating with vehicle 106 over a short-range wireless communication technique.

In some embodiments, vehicle 106 may comprise one or more ports 114 on an exterior portion or exterior surface of vehicle 106. For example, the one or more ports 114 may be located at a roof of vehicle 106 and/or a bed of vehicle 106. In some embodiments, port 114 may be used to provide power, wirelessly, e.g., via inductive charging pad (e.g., utilizing the Qi or MagSafe standard) or NFC or other suitable wireless technique, or via a wired connection, to one or more accessories, such as, for example, user device 102 and/or 104.

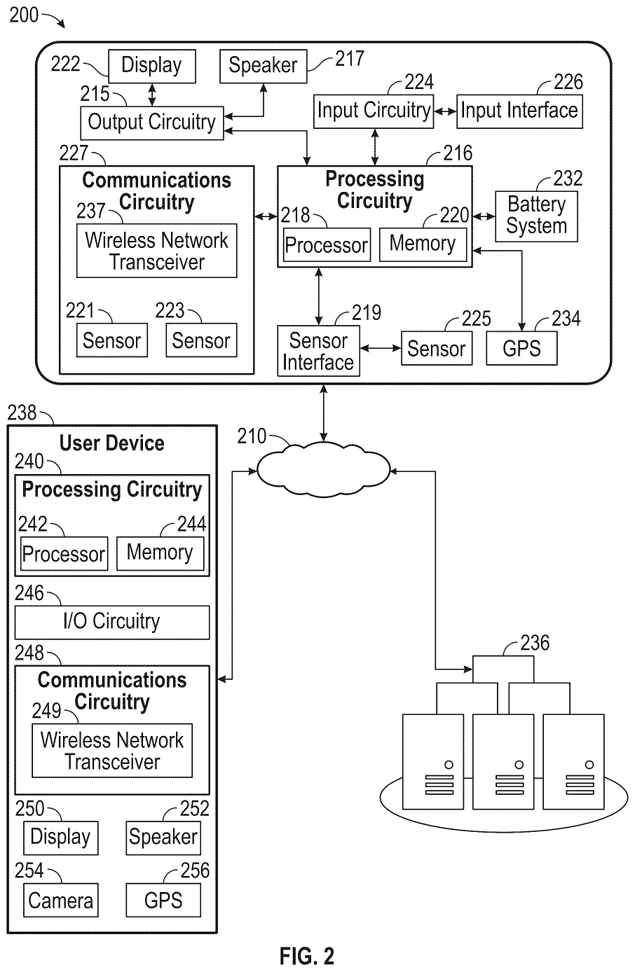

FIG. 2 shows a block diagram of components of a system for securely providing electrical power to a user device, in accordance with some embodiments of the present disclosure. System 200 may comprise vehicle 206, which may be in communication with server 236 and user device 238 via one or more networks 205 and/or short-range wireless communication techniques and/or wired techniques. In some embodiments, vehicle 206 may correspond to vehicle 106 of FIG. 1, and user device 238 may correspond to user device 102 (e.g., a mobile device, such as, for example, a smartphone) or user device 204 (e.g., such as, for example, a key fob).

Vehicle 206 may be a car (e.g., a coupe, a sedan, a truck, an SUV, a bus), a motorcycle, an aircraft (e.g., a drone), a watercraft (e.g., a boat), or any other type of vehicle or any combination thereof. In some embodiments, vehicle 206 may be configured to operate autonomously or semi-autonomously. Vehicle 206 may comprise processing circuitry 216 which may comprise processor 218 and memory 220. Processor 218 may comprise a hardware processor, a software processor (e.g., a processor emulated using a virtual machine), or any combination thereof. In some embodiments, processor 218 and memory 220 in combination may be referred to as processing circuitry 216 of vehicle 206. In some embodiments, processor 218 alone may be referred to as processing circuitry 216 of vehicle 206. Memory 220 may comprise hardware elements for non-transitory storage of commands or instructions, that, when executed by processor 218, cause processor 218 to operate vehicle 206 in accordance with embodiments described above and below. Processing circuitry 216 may be communicatively connected to components of vehicle 206 via one or more wires, or via wireless connection.

In some embodiments, processing circuitry 216 (and/or processing circuitry 240 of user device 238 and/or processing circuitry of one or more servers 236) may be configured to execute computer-readable instructions to regulate the process of establishing a charging session between user device 238 and vehicle 206. For example, vehicle 206 may be configured to execute one or more applications to perform the techniques described above and below.

Processing circuitry 216 may be communicatively connected to input interface 226 (e.g., a steering wheel, a touch screen display, buttons, knobs, a microphone or other audio capture device, or any other suitable input interface or any combination thereof) via input circuitry 224. In some embodiments, a driver or operator or passenger of vehicle 206 may be permitted to select certain settings and/or provide other input in connection with the operation of vehicle 206 via input interface 226. For example, input interface 226 may receive input (e.g., tactile, voice, haptic, biometric or any other suitable input) or a request (e.g., from user device 238) to pair vehicle 206 and user device 238. In some embodiments, input interface 226 may be communicatively connected to one or more cameras (and/or any other suitable types of sensors), which may be configured to capture data related to an interior or exterior environment of vehicle 206. Such images may be transmitted to processing circuitry 216 and used to, e.g., detect obstacles or vehicles in a vicinity of vehicle 206, for facial recognition purposes to authenticate a driver of vehicle 206, and/or for any other suitable purpose.

Processing circuitry 216 may be communicatively connected to display 222 and speaker 217 by way of output circuitry 215. Display 222 may be located at a dashboard of vehicle 206 and/or at a heads-up display at a windshield of vehicle 206. Display 222 may comprise an LCD display, an OLED display, an LED display, a touch screen display, or any other type of display or any combination thereof. Speaker 217 may be located at any location within the cabin of vehicle 206, e.g., at the dashboard of vehicle 206, on an interior portion of the vehicle door, and/or any other suitable portion of vehicle 206, and may be configured to provide audio output to a driver or operator or passenger of vehicle 206.

In some embodiments, processing circuitry 216 may be communicatively connected to GPS 234 or other positioning device of vehicle 206, where the driver or operator or passenger may interact with the GPS system via input interface 116. GPS 234 may be in communication with multiple satellites and/or servers 136 remote from vehicle 206 to ascertain the location of vehicle 206 and provide navigation directions to processing circuitry 216. As another example, the positioning device may operate on terrestrial signals, such as cell phone signals, Wi-Fi signals, or ultra-wideband signals to determine a location of vehicle 206.

Processing circuitry 216 may be communicatively connected to communications circuitry 227. Communications circuitry 227 may comprise wireless network transceiver 237 which may comprise any suitable hardware and/or software operable to send and receive wireless (and/or wired) signals between vehicle 206 and external devices such as, for example, network or user devices (e.g., user device 238, server 236 and/or a Wi-Fi access point and/or a satellite) and/or any other suitable computing devices. Communications circuitry 227 may include or be associated with an antenna and other control circuitry (e.g., protocol converters, rate converters, signal converters), or any combination thereof. Wireless network transceiver 237 may comprise one or more components to facilitate communication over any suitable network or communication method (e.g., the Internet, short-range radio communication such as, for example, Bluetooth, BLE, NFC). For example, communications circuitry 227 may be configured to access the Internet, a local area network, a wide area network, a Bluetooth-enabled device, an NFC-enabled device, any other suitable device using any suitable protocol, or any combination thereof. In some embodiments, communications circuitry 227 may comprise a sensor configured to advertise a vehicle identifier (e.g., over a BLE link). In some embodiments, communications circuitry 227 may comprise multiple different communications circuits, each being respectively configured to facilitate a different type of communication.

In some embodiments, communications circuitry 227 or wireless network transceiver 237 may comprise sensors 221 and 223. In some embodiments, sensor 221 may correspond to a driver's left front door sensor, operable to communicate whether such door is open and/or which may transmit data to or wireless network transceiver 237 indicative of whether sensor 221 is connected to user device 238 via a short-range wireless communication protocol. In some embodiments, sensor 223 may correspond to a sensor in the vehicle's center console which may transmit data to or wireless network transceiver 237 indicative of whether sensor 223 is connected to user device 238 via a short-range wireless communication protocol.

Processing circuitry 216 may be communicatively connected (e.g., by way of sensor interface 219) to any suitable number and types of sensors. In some embodiments, any suitable number of sensor 225 may be may be positioned at a variety of locations of vehicle 206, and may be one or more of a variety of types, e.g., an image sensor, an ultrasonic sensor, a radar sensor, LED sensor, LIDAR sensor, and/or any other suitable sensor configured to measure the distance between vehicle 206 and an object in a surrounding environment of the vehicle (e.g., by outputting a light or radio wave signal, and measuring a time for a return signal to be detected and/or an intensity of the returned signal, and/or performing image processing on images captured by the image sensor of the surrounding environment of vehicle 206).

Processing circuitry 216 may be communicatively connected to battery system 232, which may be configured to provide power to one or more of the components of vehicle 206 during operation. In some embodiments, vehicle 206 may be an electric vehicle or a hybrid electric vehicle. It should be appreciated that FIG. 2 only shows some of the components of vehicle 206, and it will be understood that vehicle 206 also includes other elements commonly found in vehicles (e.g., electric vehicles), e.g., a motor, brakes, wheels, wheel controls, turn signals, windows, doors, and/or any other suitable components.

User device 238 may be, for example, a smartphone, tablet, a key fob, or any suitable personal computing device operable to communicate with vehicle 206 and server 236, e.g., by way of communications circuitry 248. In some embodiments, user device 238 may be configured to communicate with vehicle 206 by way of a wired connection (e.g., USB connection or other data cable).

User device 238 may comprise processing circuitry 240, processor 242, memory 244, which may be implemented in a similar manner as processing circuitry 216, processor 218 and memory 220, respectively. User device 238 may further comprise input/output (I/O) circuitry 246 (e.g., coupled to a microphone and/or a touch screen and/or other suitable inputs), communications circuitry 248, display 250, speaker 252, camera 254 and GPS system 256, which may be implemented similarly to input circuitry 224 and output circuitry 215, communications circuitry 248, display 222, speaker 217 images sensor(s) coupled to sensor interface 219, and GPS 234, respectively.

Communications circuitry 248 may comprise wireless network transceiver 249 which may comprise one or more components configured to receive and transmit signals using various communication techniques. For example, communications circuitry 248 may comprise a wireless network transceiver 249 may enable user device 238 to communicate with vehicle 206 over a first communication path (e.g., BLE, NFC or other short-range communication technique) and communications circuitry 248 may enable user device 238 to communicate with server 236 over a second communication path (e.g., network 210, such as, for example, the Internet, a satellite network, or any other suitable network, or any combination thereof). In some embodiments, communications circuitry 227 may comprise multiple different communications circuits, each being respectively configured to facilitate a different type of communication.

In some embodiments, user device 238 may be a key fob which may comprise one or more buttons or other features for receiving haptic input or other suitable input from a user. For example, in some embodiments, the key fob comprises a number of buttons (e.g., two, three, four, or more than four buttons) that respectively correspond to a function or command. The key fob may include a battery to provide electrical power, an antenna for transmitting and receiving signals, and processing circuitry 240 may convert user selections (e.g., presses of a button) to an electrical signal which may then be converted to a wireless signal (e.g., via the antenna).

Server 236 may comprise a plurality of servers configured to remotely provide cloud computing resources (e.g., storage, processing, software applications, or any other suitable resources, or any combination thereof) to other components of system 200, e.g., user device 238 and/or vehicle 206. In some embodiments, server 236 may be associated with a manufacturer of vehicle 206, and may be configured to store (e.g., a cloud-based storage system such as in memory 278 or a database associated with server 236) information related to each vehicle sold by the manufacturer and related to an owner of each vehicle, e.g., login credentials associated with a user profile of the vehicle owner with the manufacturer, which may be generated for and provided to the user upon his or her purchase of vehicle 206. Such information may be stored in any suitable format such as, for example, a database, a lookup table, a set of flags, one or more ASCII characters or words (e.g., in a text file), any other format, or any combination thereof.

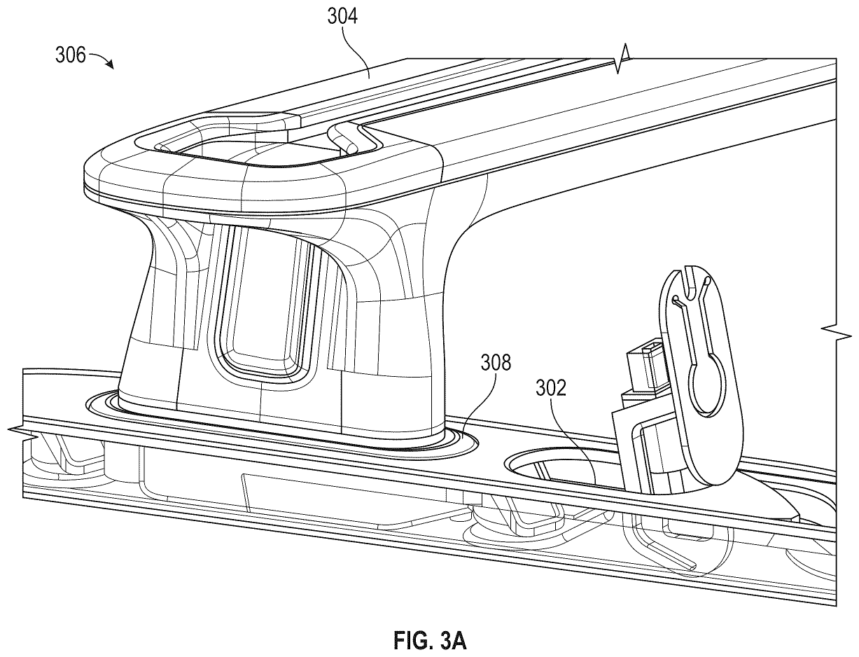

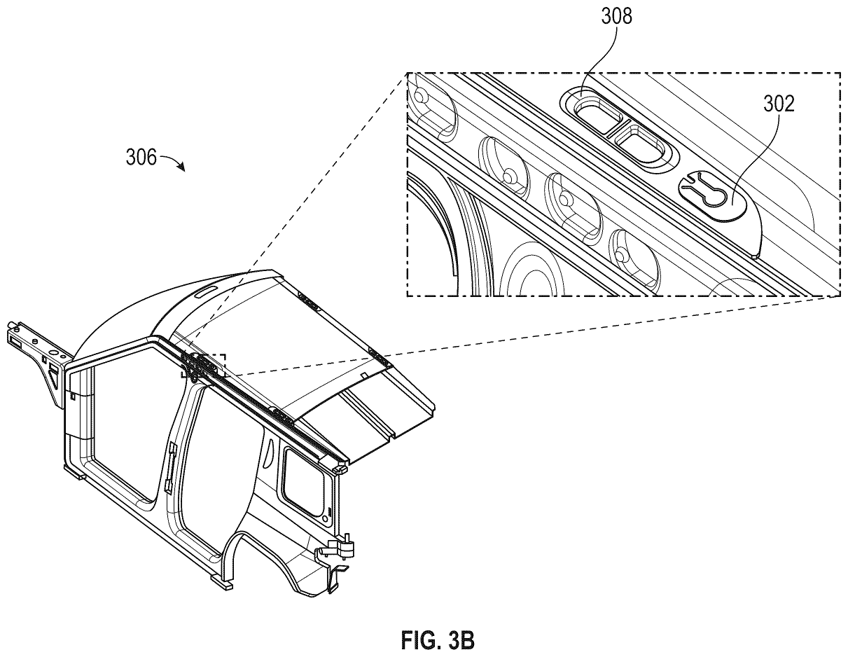

FIGS. 3A-3B shows an illustrative port provided at an exterior portion of a vehicle, in accordance with some embodiments of this disclosure. As shown in FIG. 3A, a port 314 (which may corresponds to port 114 of FIG. 1) may be provided for supplying electrical power to a user device (e.g., user device 102 and/or 104 of FIG. 1). Port 302 may be provided at an exterior portion or exterior surface of vehicle 306, e.g., at one or more lateral sides of a roof of vehicle 306. FIG. 3B shows that ports 302 and 308 may be located on, e.g., one or more sides of a roof of vehicle 306, or at any other suitable location on an exterior portion or exterior surface of vehicle 306. In some embodiments, port 302 and/or 308 may be a charging port utilizing an inductive coil or other suitable wireless charging port, e.g., configured to transmit wireless power to user device 102 or 104 of FIG. 1 or another suitable accessory (e.g., camping equipment, cooking equipment, an electric bicycle, or any other suitable accessory, or any suitable combination thereof).

In some embodiments, vehicle 306 may enable accessory 304 to be electrically coupled to port 308, as is discussed in more detail in commonly-owned U.S. Patent Application Publication No. 2024/0217461 A1, corresponding to U.S. application Ser. No. 18/186,107 filed Mar. 17, 2023, the contents of which are hereby incorporated by reference herein in their entirety. In addition, the present disclosure may utilize one or more of the techniques described in commonly-owned U.S. Patent Application Publication No. 2024/0220596 A1, corresponding to U.S. application Ser. No. 18/186,1026 filed Mar. 17, 2023, the contents of which are hereby incorporated by reference herein in their entirety. In addition, the present disclosure may utilize one or more of the techniques described in commonly-owned U.S. Patent Application Publication No. 2024/0011617 A1, corresponding to U.S. application Ser. No. 17/942,953 filed Sep. 12, 2022, the contents of which are hereby incorporated by reference herein in their entirety.

Port 302 may be configured to supply electric power to (and/or transfer data to or receive data from) an accessory, such as, for example, user device 102 (e.g., a smartphone) via an electrical connector (e.g., electrical terminals, pins or contacts), or user device 102 may otherwise be coupled (e.g., wirelessly) to port 302. In some embodiments, port 302 may be associated with a mechanical component for physically securing user device 102 or other accessory to vehicle 306. In some embodiments, port 320 may comprise component 310, which is shown in FIG. 3A in an open position, e.g., rotated upwards, and which may comprise a wireless charging pad and/or a physical connector, to couple to a user device or other accessory. FIG. 3B shows component 310 in a closed position, e.g., to protect components of port 302 from an environment external to vehicle 306.

In some embodiments, port 302 may include various features to protect the electrical component from corrosion as a result of having an electrical current flowing through it while being exposed to an external environment. For example, one or more portions of port 302 may be constructed from electrically-conductive material that is corrosion or wear resistant and also has high surface hardness, e.g., by plating or cladding the one or more portions using metals such as gold, platinum, or palladium, but base metals with similar properties may also be appropriate, such as copper, aluminum, or nickel. Alternatively or additionally, any electrical current flowing to port 302 may be terminated upon an accessory decoupling from port 302, e.g., the absence of the electrical current may reduce corrosion despite the one or more portions of port 302 remaining exposed to an external environment. In some embodiments, port 302 may include insulator sections around electrical contacts to help hold the contacts in place while separating the contacts from any surrounding surface and/or structures to prevent the electrical current flowing through the electrical contacts from being transferred to the surroundings.

In some embodiments, port 302 may be used provide electrical power from an exterior portion of vehicle 306, to sufficiently charge user device 102 to enable a user to access and turn on vehicle 306, e.g., in a scenario where a user uses their user device 102 as a PAK and finds the battery level of their user device 102 has completely ran out or substantially ran out (and thus may have not be able to start their vehicle).

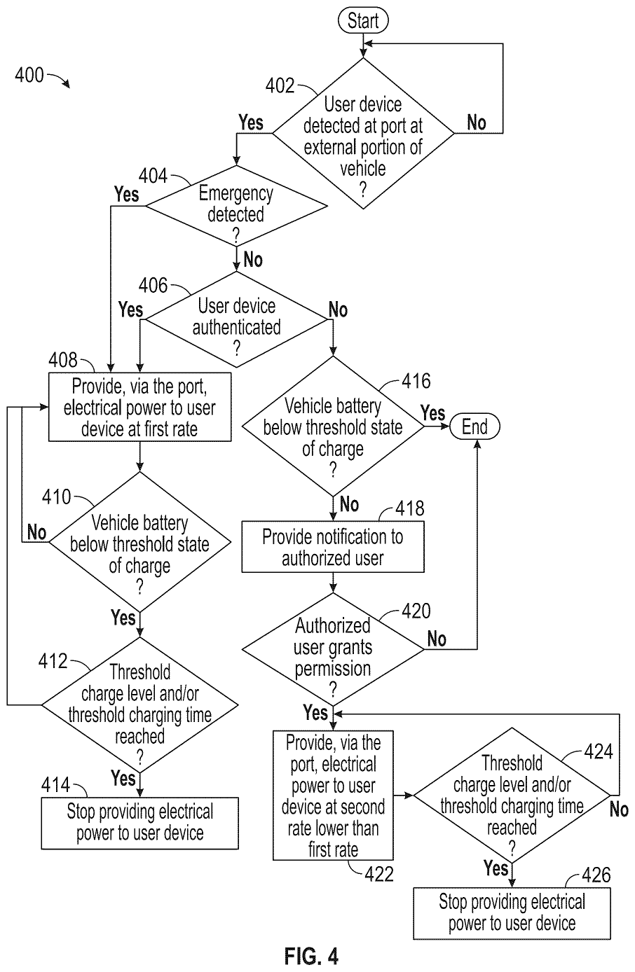

FIG. 4 shows a flowchart of an illustrative process 400 for providing electrical power to an accessory via a port located at an exterior portion of a vehicle, in accordance with some embodiments of this disclosure. In some embodiments, process 400 may be performed by any suitable entity, circuitry (e.g., executing instructions for one or more applications) and/or other components described in FIGS. 1-3. In some embodiments, vehicle 306 may have its electric motor off and have its electronics substantially turned off (with the exception of one or more ECUs used in process 400) or in a sleep mode, and may be stationary and parked, while process 400 is performed.

At 402, vehicle 306 may determine whether user device 102 (e.g., a smartphone) is detected at a port 302 of vehicle 306, e.g., based on a signal received via port 302 at, for example, an ECU associated with port 302. In some embodiments, such detection at 402 may be performed using NFC, or another suitable mechanism. For example, port 302 may comprise or be proximate to a radio frequency (RF) sensor (e.g., NFC reader), for detecting the radio frequency signals transmitted from a radio frequency emitter, such as an NFC tag, on user device 102. The RF signals from the radio frequency emitter may include user device 102 data, which may be analyzed by processing circuitry 216, or other processing circuitry, e.g., associated with one or more electronic control units (ECUs) for port 302.

In some embodiments, the detecting at 402 may comprise detecting whether user device 102 has physically made contact with port 302, e.g., via respective electrical pins (e.g., a USB or micro-USB connection or USB-C or any other suitable connection). In some embodiments, the detecting at 402 may comprise detecting that user device 102 has arrived in the proximity of the port such that port 302 is able to detect the signal (e.g., via Bluetooth, NFC, etc.) from user device 102. Based on the detecting at 402, a signal may be transmitted indicating that user device 102 is seeking to couple with port 302 to receive electrical power through port 302. An affirmative determination at 402 may cause processing to proceed to 402; otherwise process 400 may wait for detecting a user device at port 302.

At 404, vehicle 306 may determine whether a location of vehicle 306 is associated with an emergency situation. For example, vehicle 306 may receive data via one or more sensors and/or from server 236 via network 210 indicating that a hurricane (or other natural disaster or other public safety incident) is imminent, is occurring, or has recently occurred at the current location of vehicle 306, or vehicle 206 may otherwise receive a public service announcement indicating such information. In some embodiments, if an emergency is detected, processing may proceed to 408 (e.g., step 406 may be bypassed); otherwise, processing may proceed to 406. For example, to help support the community during the natural disaster, vehicle 306 may permit stranded or people otherwise facing a challenging time to be able to charge their smartphone via port 302, regardless of whether such person is an authenticated user associated with vehicle 306.

At 406, vehicle 306 may determine whether a user and/or a user device having been detected at 402 is authenticated. For example, data received via NFC or other suitable connection with user device 102 may include an identifier of user device 102 and/or a user associated with user device 102, and one or more ECUs of vehicle 306 (and/or server 236) may compare the identifier to one or more registered identifiers for vehicle, e.g., a registered owner of vehicle 306, registered secondary drivers of vehicle 306, and/or other devices or users permitted to have their devices be supplied power by vehicle 306 via port 302 (e.g., based on being approved by the owner of vehicle 306). In some embodiments, a camera of vehicle 306 may capture an image of a user in a vicinity of vehicle 306, and authenticate the user device and/or user using facial recognition of an authorized user or other biometric data. In some embodiments, vehicle 306 may begin charging a user device, e.g., have 0% battery power, until such user device boots up, at which point authentication may be performed. In some embodiments, an initial charging speed while the user device is booting up (and/or while portions of vehicle 306 are being woken up) and prior to authentication may be lower than after the charging speed provided via port 302 after a device is authenticated. For example, the electrical power may be provided at the second level (indicated at 422) may be transferred to the user device prior to determining whether the user device is authenticated, since the user device's transceiver may need some amount of electrical power to be able to transmit the user device data that is used to make the authentication determination.

If the user device and/or user is authenticated, processing may proceed to 408; otherwise, processing may proceed to 416. In some embodiments, a button or a user interface element may be provided in an interior or exterior of vehicle 306, selectable to permit electrical power to begin being provided at a particular charging rate. In some embodiments, port 302 may be provided under a glass roof/tinted body panel, using a roof rack and/or via a solar pack of vehicle 306.

At 408, having authenticated user device 102 and/or the user associated with user device 102, vehicle 306 may provide, via the port, electrical power to the user device at first rate, e.g., a fast charging speed of 120W, or any other suitable charging speed greater than the second charging rate indicated at 422. In some embodiments, vehicle 306 may continue to supply electrical power to vehicle 306 via port 302 for as long as desired by the user, or as long as a battery of vehicle 306 is estimated to have a current state of charge above a threshold value as indicated at 410), or until a threshold charge level for the user device (and/or a threshold charging time, e.g., 10 minutes, as measured by a timer) is reacted, as indicated at 412. At 414, vehicle 306 may, based on one or more of the determinations of 410 and/or 412 or based on user input or user action (e.g., removing user device 102 from port 302), stop providing electrical power to vehicle 306.

In some embodiments, at 406, having determined that the user device and/or user detected at port 302 is not authenticated, vehicle 306 may determine whether a state of charge of vehicle 306 is below a threshold. If so, processing may conclude, as the unauthenticated user may not be permitted to further drain the battery. Alternatively, processing may proceed to 418, and/or 416 may not be performed, in some embodiments.

At 418, vehicle 306 may provide notification to an authorized user, e.g., a text message, push notification, email or other electronic message to a registered owner of vehicle 306, regarding the attempt of an unauthenticated user to be supplied electrical power via port 302 of vehicle 306. In some embodiments, the notification includes an image or live video footage captured by a camera of vehicle 306 of an environment of vehicle 306, to allow the authorized user to see and potentially determine an identity of a user attempting to his port 302 for electrical power. At 420, if the authorized user grants permission, e.g., affirmatively responds to the notification, processing may proceed to 422; otherwise, processing may end, and electrical power may be withheld, by one or more ECUs, from the unauthenticated user's device.

At 422, vehicle 306 may provide electrical power to the unauthenticated user's device at a second charging rate that is lower than the first charging rate indicated at 408. For example, the second charging rate may be an average charging rate, or below average charging rate. In some embodiments, the second rate used for unauthenticated devices may be significantly lower than the first rate used for authenticated devices.

At 424, vehicle 306 may determine whether a threshold charge level has been reached by the unauthenticated user device, and/or whether the unauthenticated user device has been charged for at least a threshold period of time. For example, such electrical power may be provided for only 5 minutes, or until the user device reaches 10% battery life, for example, and vehicle 306 may receive one or more signals via port 302 as to whether such thresholds have been reached. If one of such thresholds at 424 are met, or user input is received (e.g., from an authorized user, indicating to end the charging session, or the unauthenticated user removes their user device from port 302), vehicle 306 may stop providing electrical power to the unauthenticated user device. In some embodiments, only authenticated devices may be provided any electrical power at all.

In some embodiments, a time period during which electrical power is supplied via port 302 for a single session is set based on, e.g., a minimum time period to have sufficient electric charge in a battery of user device 102 to unlock and/or start vehicle 306. In some embodiments, the time period may be set differently for different types of devices, e.g., based on average charge time for iOS devices and Android devices. In some embodiments, a number of charging sessions provided via port 302 may be limited to a certain number over a time period, e.g., 2 charging sessions per hour, or only one unique device per hour, may be permitted. In some embodiments, a particular unauthenticated device may only be permitted, e.g., 1 charge per week, to avoid such unauthenticated device from becoming a daily or too frequent consumer. In some embodiments, a charging session via port 302 is only permitted if the user device being coupled to port 302 has below a certain threshold of charge (e.g., below 5%, or 1%, or any other suitable threshold).

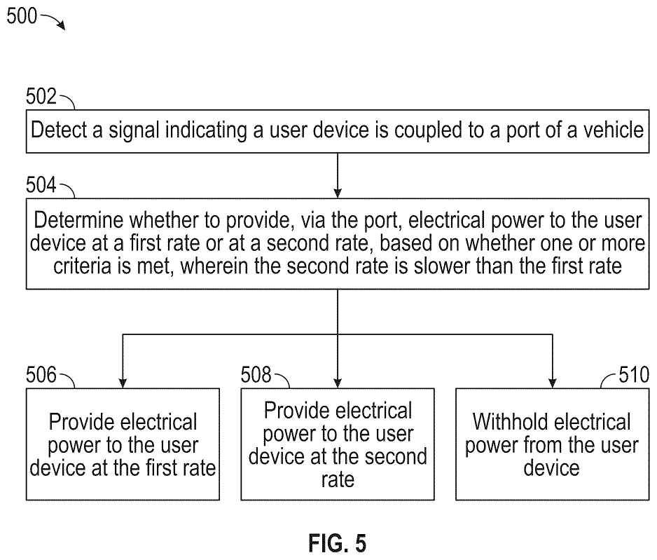

FIG. 5 shows a flowchart of an illustrative process 500 for providing electrical power to an accessory via a port located at an exterior portion of a vehicle, in accordance with some embodiments of this disclosure. In some embodiments, process 500 may be performed by any suitable entity, circuitry (e.g., executing instructions for one or more applications) and/or other components described in FIGS. 1-3. In some embodiments, vehicle 106 or 306 may have its electric motor off and have its electronics substantially turned off (with the exception of one or more ECUs used in process 500) or in a sleep mode, and may be stationary and parked, while process 500 is performed.

At 502, vehicle 106 may detect a signal indicating that user device 102 or 104 is coupled to port 114. In the example of FIG. 3, vehicle 306 may determine whether user device 102 (e.g., a smartphone) is coupled to a port 302 of vehicle 306, e.g., based on a signal received via port 302 at, for example, an ECU associated with port 302.

At 504, vehicle 106 or vehicle 306 may determine whether to provide, via the port 114 or port 302, electrical power to the user device 102 at a first rate or at a second rate, based on whether one or more criteria is met, where the second rate is slower than the first rate. For example, the criteria may include whether a state of emergency is associated with a location of vehicle 106 or 306, whether the user device 102 is associated with an authenticated user of the vehicle 106 or 306, whether an authenticated user has provided approval or confirmation with respect to the user device, whether a state of charge of a battery of the vehicle is below a threshold, and/or other suitable criteria.

Process 500 may include, based on the processing at 504, the vehicle providing electrical power to the user device at the first rate (at 506), the vehicle providing electrical power to the user device at the first rate (at 508), or the vehicle withholding electrical power from the user device (at 510). For example, electrical power may be provided to the user device at the first rate at 506 upon determining that the location of the vehicle 106 is determined to be associated with a state of emergency, that the user device is associated with an authenticated user of the vehicle, based on receiving approval from an authenticated user of the vehicle with respect to the user device coupled to the port, and/or based on a determined state of charge of a battery of the vehicle and/or a battery of the user device, and/or based on other suitable criteria.

As another example, at 508, electrical power may be provided at the second rate to a user device of a user that is not authenticated (e.g., for a certain, limited period of time), based on determining that there is no state of emergency associated with a location of the vehicle, based on receiving approval from a user device of an authenticated user of the vehicle with respect to the user device coupled to the port, and/or based on a determined state of charge of a battery of the vehicle and/or a battery of the user device, and/or based on other suitable criteria.

As another example, at 510, electrical power may be withheld from the user device based on determining that there is no state of emergency associated with a location of the vehicle, based on the user device coupled to the port being associated with an unauthenticated user, based on a lack of approval from an authenticated user to permit provision of electrical power to the unauthenticated user, based on a state of charge of a battery of the vehicle being below a threshold, based on state of charge of a battery of the user device being above a threshold, and/or based on other suitable criteria.

The foregoing is merely illustrative of the principles of this disclosure, and various modifications may be made by those skilled in the art without departing from the scope of this disclosure. The above-described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof.

We claim:

1. A vehicle comprising:
a port located at an exterior portion of the vehicle; and
processing circuitry configured to:
detect a signal indicating a user device is coupled to the port; and
determine whether to provide, via the port, electrical power to the user device at a first rate or at a second rate, based on whether one or more criteria is met, wherein the second rate is slower than the first rate.

2. The vehicle of claim 1, wherein the one or more criteria comprises whether a state of emergency is associated with a location of the vehicle, and wherein the processing circuitry is further configured to:
determine that the state of emergency is associated with the location of the vehicle; and
based on determining that the state of emergency is associated with the location of the vehicle, provide, via the port, electrical power to the user device at the first rate.

3. The vehicle of claim 1, wherein the one or more criteria comprises whether the user device is associated with an authenticated user of the vehicle, and the processing circuitry is further configured to:
determine that the user device is associated with an authenticated user of the vehicle; and
based on determining that the user device is associated with an authenticated user of the vehicle, provide, via the port, electrical power to the user device at the first rate.

4. The vehicle of claim 3, wherein the processing circuitry is further configured to, prior to determining that the user device is associated with the authenticated user of the vehicle, provide, via the port, electrical power to the user device at the second rate.

5. The vehicle of claim 1, wherein the one or more criteria comprises whether the user device is associated with an authenticated user of the vehicle, and the processing circuitry is further configured to:
determine that the user device is not associated with an authenticated user of the vehicle; and
based on determining that the user device is not associated with an authenticated user of the vehicle, provide, via the port, electrical power to the user device at the second rate for a period of time, and, upon determining that the period of time has elapsed, stop providing the electrical power to the user device via the port.

6. The vehicle of claim 1, wherein the one or more criteria comprises whether the user device is associated with an authenticated user of the vehicle, and the processing circuitry is further configured to:
determine that the user device is not associated with an authenticated user of the vehicle;
based on determining that the user device is not associated with an authenticated user of the vehicle, provide a notification to a user device of an authorized user of the vehicle indicating that an unauthenticated user is attempting to use the port to receive electrical power for their user device; and
based on receiving approval from the user device of the authenticated user of the vehicle, provide, via the port, electrical power to the user device at the first rate or the second rate.

7. The vehicle of claim 6, wherein the notification further comprises a video of the unauthenticated user in a vicinity of the vehicle.

8. The vehicle of claim 1, wherein the one or more criteria comprises whether the user device is associated with an authenticated user of the vehicle, and the processing circuitry is further configured to:
determine that the user device is not associated with an authenticated user of the vehicle;
based on determining that the user device is not associated with an authenticated user of the vehicle, provide a notification to a user device of an authorized user of the vehicle indicating that an unauthenticated user is attempting to use the port to receive electrical power for their user device; and
based on receiving no response to the notification from the user device of the authorized user of the vehicle, or based on receiving selection of a negative option, determine to withhold the electrical power from the user device.

9. The vehicle of claim 1, wherein the one or more criteria comprises whether a state of charge of a battery of the vehicle is below a threshold, and wherein the processing circuitry is further configured to:
determine that the state of charge of the battery of the vehicle is below the threshold; and
based on determining that the state of charge of the battery of the vehicle is below the threshold, provide, via the port, electrical power to the user device at the first rate or the second rate for a period of time, and, upon determining that the period of time has elapsed, stop providing the electrical power to the user device via the port.

10. The vehicle of claim 1, wherein the one or more criteria comprises whether the user device is associated with an authenticated user of the vehicle and whether a state of charge of a battery of the vehicle is below a threshold, and wherein the processing circuitry is further configured to:
determine that the user device is not associated with an authenticated user of the vehicle;
determine that the state of charge of the battery of the vehicle is below the threshold; and
based on determining that the user device is not associated with an authenticated user of the vehicle and that the state of charge of the battery of the vehicle is below the threshold, determine to withhold the electrical power from the user device.

11. A method comprising:
detecting, by processing circuitry, a signal indicating a user device is coupled to a port, wherein the port is located at an exterior portion of a vehicle;
determining, by the processing circuitry, whether to provide, via the port, electrical power to the user device at a first rate or at a second rate, based on whether one or more criteria is met, wherein the second rate is slower than the first rate.

12. The method of claim 11, wherein the one or more criteria comprises whether a state of emergency is associated with a location of the vehicle, and wherein the method further comprises:
determining that the state of emergency is associated with the location of the vehicle; and
based on determining that the state of emergency is associated with the location of the vehicle, providing, via the port, electrical power to the user device at the first rate.

13. The method of claim 11, wherein the one or more criteria comprises whether the user device is associated with an authenticated user of the vehicle, and the method further comprises:
determining that the user device is associated with an authenticated user of the vehicle; and
based on determining that the user device is associated with an authenticated user of the vehicle, providing, via the port, electrical power to the user device at the first rate.

14. The method of claim 13, further comprising, prior to determining that the user device is associated with the authenticated user of the vehicle, providing, via the port, electrical power to the user device at the second rate.

15. The method of claim 11, wherein the one or more criteria comprises whether the user device is associated with an authenticated user of the vehicle, and the method further comprises:
determining that the user device is not associated with an authenticated user of the vehicle; and
based on determining that the user device is not associated with an authenticated user of the vehicle, providing, via the port, electrical power to the user device at the second rate for a period of time, and, upon determining that the period of time has elapsed, stop providing the electrical power to the user device via the port.

16. The method of claim 11, wherein the one or more criteria comprises whether the user device is associated with an authenticated user of the vehicle, and wherein the method further comprises:
determining that the user device is not associated with an authenticated user of the vehicle;
based on determining that the user device is not associated with an authenticated user of the vehicle, providing a notification to a user device of an authorized user of the vehicle indicating that an unauthenticated user is attempting to use the port to receive electrical power for their user device; and
based on receiving approval from the user device of the authenticated user of the vehicle, providing, via the port, electrical power to the user device at the first rate or the second rate.

17. The method of claim 16, wherein the notification further comprises a video of the unauthenticated user in a vicinity of the vehicle.

18. The method of claim 11, wherein the one or more criteria comprises whether the user device is associated with an authenticated user of the vehicle, and wherein the method further comprises:
determining that the user device is not associated with an authenticated user of the vehicle;
based on determining that the user device is not associated with an authenticated user of the vehicle, providing a notification to a user device of an authorized user of the vehicle indicating that an unauthenticated user is attempting to use the port to receive electrical power for their user device; and
based on receiving no response to the notification from the user device of the authorized user of the vehicle, or based on receiving selection of a negative option, determining to withhold the electrical power from the user device.

19. The method of claim 11, wherein the one or more criteria comprises whether a state of charge of a battery of the vehicle is below a threshold, and wherein the method further comprises:
determining that the state of charge of the battery of the vehicle is below the threshold; and
based on determining that the state of charge of the battery of the vehicle is below the threshold, providing, via the port, electrical power to the user device at the first rate or the second rate for a period of time, and, upon determining that the period of time has elapsed, stop providing the electrical power to the user device via the port.

20. The method of claim 11, wherein the one or more criteria comprises whether the user device is associated with an authenticated user of the vehicle and whether a state of charge of a battery of the vehicle is below a threshold, and wherein the method further comprises:
determining that the user device is not associated with an authenticated user of the vehicle;
determining that the state of charge of the battery of the vehicle is below the threshold; and
based on determining that the user device is not associated with an authenticated user of the vehicle and that the state of charge of the battery of the vehicle is below the threshold, determining to withhold the electrical power from the user device.
